(19) United States
(12) Patent Application Publication
(10) Pub. No.: US 2002/0102342 A1
(43) Pub. Date: Aug. 1, 2002

(54) 1,5-Anhydro-D-fructose substituted with a hydrophobic group for use as anti-oxidant and/or emulsifier

(76) Inventors: Soren Moller Andersen, Edmonton (CA); Jan Marcussen, Copenhagen K (DK); Inge Lundt, Kokkedal (DK); Shukun Yu, Malmoe (SE)

Correspondence Address: FROMMER LAWRENCE & HAUG LLP, 745 Fifth Avenue, New York, NY, 10151, US

(21) Appl. No.: 09/957,714

(22) Filed: Sep. 18, 2001

Related U.S. Application Data
(63) Continuation-in-part of application No. PCT/IB00/00345, filed on Mar. 16, 2000.

(30) Foreign Application Priority Data
Mar. 19, 1999 (GB) 9906458.6

(51) Int. Cl. A23L 1/00

(52) U.S. Cl. 426/541; 426/658; 536/1.11

(57) ABSTRACT

The present invention provides a derivatised anhydrofructose comprising a hydrophobic group linked (directly or indirectly) to a C of an anhydrofructose moiety.

The present invention relates to an anti-oxidant composition.

Anti-oxidants are required in many applications, for example, food preservation.

Food degradation from various sources are recognized in the literature and individual chemicals are known which will inhibit one aspect or another of degradation derived from a single source, such as oxidation.

Antioxidants are widely used in food and biological systems. In food systems they are especially used to prevent oxidation of unsaturated fatty acids and in biological systems they protect cell components from oxidative stress.

Fatty bodies have a tendency to be oxidized, even at ambient temperature and this oxidation (or rancidness) makes them acquire new properties, principally of taste or smell, which are generally considered as undesirable when these fatty bodies are incorporated, for example, in food compositions or in cosmetic compositions.

There are currently employed, in compositions containing fatty bodies or materials, protective agents which, in fact, play the role of an anti-oxidant.

Among known anti-oxidants, ascorbic acid is currently used which acts principally by direct absorption of oxygen. However, ascorbic acid is only very slightly soluble in fatty bodies and it is consequently difficult to use in order to protect the fatty material against oxidation. Moreover, although ascorbic acid may inhibit enzymatic browning it promotes non-enzyrnatic browning, and therefore may not be used in many applications.

In order to solubilise the ascorbic acid molecule in fatty materials, it has been proposed to use various ascorbyl esters such as, for example, ascorbyl stearate, palmitate or laurate; see for example, the article of C. F. Bourgeois, “Revue Francaise des Corps Gras”, No. 9, pages 353-356 (September 1981).

It is also known, apart from their own anti-oxidant properties, that ascorbic derivatives have the additional property of improving the activity of anti-oxidant agents such as tocopherols or cafeic acid and its esters, by favoring the regeneration of these anti-oxidant agents; see for example H. S. Olcott, “Oil Soap”, 18, (1941), 77 and U.S. Pat. 2,462,663.

Various improvements of these binary anti-oxidant agents, of the ascorbic derivatives+tocopherols or ascorbic derivatives+cafeic derivatives types have been proposed, by providing for the addition of a third constituent which again improves anti-oxidant effects. Among the third constituents of these ternary systems, there can be mentioned, principally, p-aminobenzoic acid (U.S. Pat. No. 2,462,633), phospholipids (R. W. Riemenschneider et al., “Oil Soap” 1941, 47) and amines (Klaui, “The Functional (Technical) Uses of Vitamins”, ed. by M. Stein, University of Nottingham Seminar Vitamins, London, England, 1971, page 110).

It is also known that sulfiting agents including sulfur dioxide, sodium sulfite, sodium and potassium bisulfite and sodium and potassium metabisulfite act as anti-oxidants and possess the ability to preserve vegetable food products. Sulfites have also been employed as preservatives in prepared foods such as flavored beverages, syrup concentrates, wine and vinegar as well as in the processing of sugar, corn starch and shrimp. However, because of the recent increase in reported allergic reactions to these compounds, their use has fallen into disfavor. Regulatory actions involving the use of sulfites have been initiated and the former status of “generally recognized as safe” GRAS use of sulfites on raw foods and vegetables has been withdrawn by the U.S. Government Food and Drug Administration. Further labeling requirements have been imposed by the Food and Drug Administration on packaged food containing sulfites which have been added directly or indirectly.

Synthetic anti-oxidants for foodstuffs are known, such as dibutylhydroxytoluene (BHT) and butylhydroxyanisole (BHA). These compounds are, however, disadvantageous in that the amounts added to foodstuffs should be strictly controlled. For example, the maximum permissible content of BHT or BHA in fats and oils or in butter under the Japanese safety regulations must not exceed 0.02%, such limitation bringing about an insufficient anti-oxidative effect in some cases.

Besides the above named anti-oxidants for foodstuffs, several compounds have been proposed, for example alphalomega-bis(2,5-dihydroxyphenyl)alkanes are disclosed in Japanese Patent Publication No. 42-6973, and hexahydrocurcumin or octahydrocurcumin are disclosed in Japanese Patent Publication No. 48-39930. The compounds, however, have drawbacks in their synthesis and effectiveness. Generally, anti-oxidants originating in natural products are preferred to synthetic anti-oxidants in food additives from the standpoint of safety and taste.

U.S. Pat. No. 4195101 proposes use as an anti-oxidant of 2,6-dihydroxy-9-(2,5-dihydroxy- phenyl)octylphenone. It is taught that this compound serves as an anti-oxidant in foodstuffs, such as lard or the like, exhibiting higher anti-oxidative activities than the conventional anti-oxidant BFIA. U.S. Pat. No. 4195101 discloses the preparation of the compound by extraction and separation of mace, or Myristica fragrans Hautt, (a known spice) with petroleum ether, diethylether, n-hexane and carbon tetrachloride, followed by column chromatographic separation.

In a first aspect the present invention provides a derivatised anhydrofructose comprising a hydrophobic group linked (directly or indirectly) to a C of an anhydrofructose moiety.

The derivatised anhydrofructose may optionally be in admixture with any suitable carrier or diluent.

Thus, in a second aspect the present invention provides an antioxidant composition comprising the derivatised anhydrofructose comprising a hydrophobic group linked (directly or indirectly) to a C of an anhydrofructose moiety, optionally in admixture with any suitable carrier or diluent.

We have recognised that the compounds of the present invention may act as an antioxidant.

In a third aspect the present invention provides use of a derivatised anhydrofructose comprising a hydrophobic group linked (directly or indirectly) to a C of an anhydrofructose moiety, as an antioxidant.

We have recognised that the compounds of the present invention may act as an emulsifier.

In a fourth aspect the present invention provides use of a derivatised anhydrofructose comprising a hydrophobic group linked (directly or indirectly) to a C of an anhydrofructose moiety, as an emulsifier.

We have recognised that the compounds of the present invention may act as an antioxidant and as an emulsifier.

In a fifth aspect the present invention provides use of a derivatised anhydrofructose comprising a hydrophobic group linked (directly or indirectly) to a C of an anhydrofructose moiety, as an antioxidant and as an emulsifier.

Preferably, the hydrophobic group is attached indirectly to a C of an anhydrofructose moiety.

Preferably, the hydrophobic group is attached to the C₆ of the anhydrofructose moiety.

Preferably, the hydrophobic group is attached to C₆ of the anhydrofructose moiety via an ester group.

Preferably, the hydrophobic group is a fatty acid.

Preferably, the derivatised anhydrofructose is prepared by chemically derivatising anhydrofructose.

Preferably, the anhydrofructose is prepared by enzymatically derivatising anhydrofrictose.

In a sixth aspect the present invention provides a food product or a composition for use in the manufacture of a food product comprising a derivatised anhydrofructose in accordance with the present invention.

As described previously antioxidants are widely used in food and biological systems. In food systems they are especially used to prevent oxidation of unsaturated fatty acids and in biological systems they protect cell components from oxidative stress. Fatty bodies have a tendency to be oxidized, even at ambient temperature and this oxidation (or rancidness) makes them acquire new properties, principally of taste or smell, which are generally considered as undesirable when these fatty bodies are incorporated, for example, in food compositions or in cosmetic compositions.

Although anti-oxidants may be provided they may not fully exhibit their anti-oxidant activities in respect of a lipid. This is particularly problematic if the lipid is present in a lipophilic phase of a lipid/water mixture.

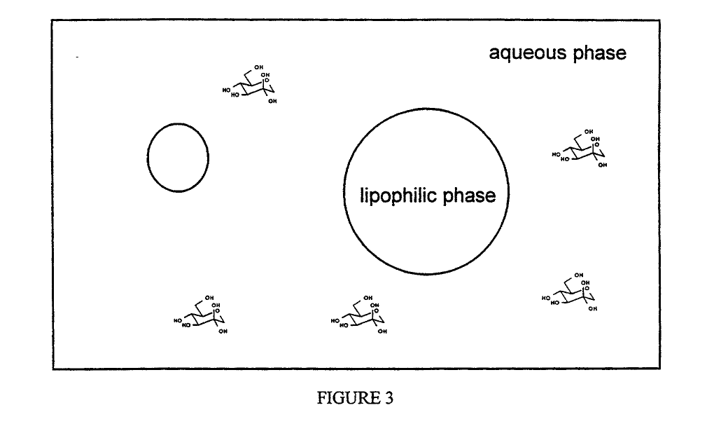

The present invention provides an antioxidant which may more fully exhibit its anti-oxidant activity in respect of a lipid. As can be seen from FIG. 3 when a compound such as 1,5-anhydro-D-fructose or ascorbic acid, is in a lipid/water suspension, the 1,5-anhydro-D-fructose is only present in the aqueous phase. To act as an antioxidant in respect of the lipophilic phase the 1,5-anhydro-D-fructose should be in contact with/or proximity to the lipophilic phase. Thus because the anhydrofructose is only or is primarily present in the aqueous phase it does not efficiently protect the lipophilic phase from oxidation.

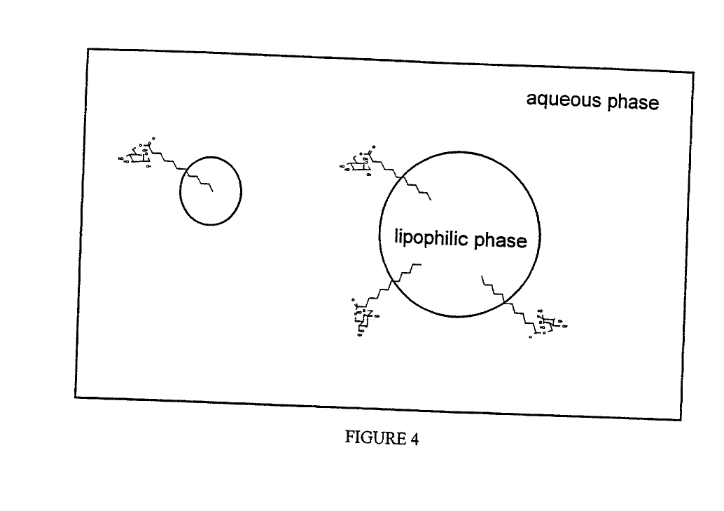

In contrast, a derivatised anhydrofructose comprising a hydrophobic group in accordance with the present invention, such as 6-O-acyl-1,5-anhydro-D-fructose, may efficiently protect the lipophilic phase from oxidation. FIG. 4 illustrates that in a compound in accordance with the present invention, namely 6-O-acyl-1,5-anhydro-D-fructose, the hydrophobic group is in contact with the lipophilic phase of the suspension. The anhydrofructose may then exhibit an anti-oxidant effect on the lipophilic phase.

Preferably the compound of the present invention is 6-O-acyl-1,5-anhydro-D-fructose.

1,5-anhydro-D-fructose, which has the formula

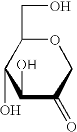

may be chemically synthesised from glucose (6 steps, 21 % overall yield) see Tetrahedron Lett. 1980, 21, 1429-1432; 1,5-anhydro-D-glucitol (4 steps, 30% overall yield) see Japanese Pat. Appl. 61-213 733 (1986). It may also be synthesised enzymatically from 1,5-anhydro-D-glucitol see J. Biochem. 1986, 99, 607-613 (analytical) and Chem. Eur. J 1998, 4(12), 2442-2455 (preparative scale), or from α-1,4-glucans (40-50% yield) see Phytochemistry, 1988, 27(11), 3401-3403.

In aqueous solution 1,5-Anhydro-D-fructose has the structure shown below

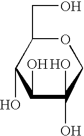

This structures represent 1,5-anhydro-D-fructose hydrate. 1,5-anhydro-D-fructose hydrate is disclosed in Biotechnol Appl Biochem., 1993, 18, 275-283.

In non-aqueous solution 1,5-Anhydro-D-fructose has the structure

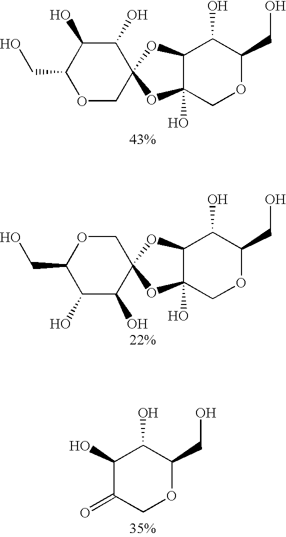

These structures may be determined by ¹³C NMR and ¹H NMR J. Carbohydrate Chemistry, 1998, 17(7), 1027-1035. J. Carbohydrate Chemistry, 1998, 17(7), 1027-1035 determined that the composition of anhydrous 1,5-anhydro-D-fructose is as follows Monomeric ketone 35%:Dimer type I 43%: Dimer type II 22%.

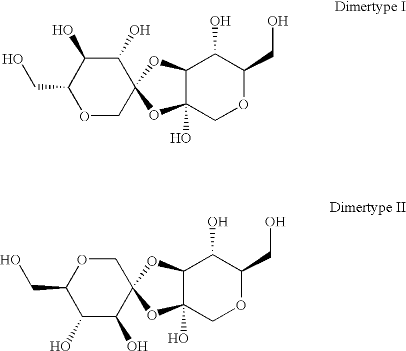

Simple Reactions

1,5-anhydro-D-fructose may be oxidised as follows

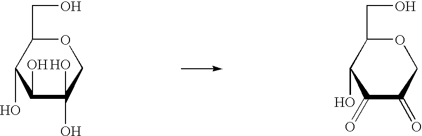

The oxidation may be performed in weakly alkaline aqueous solution of 1,5-anhydro-D-fructose+O₂. Oxidation of the —OH at the 3 position to 1,5-anhydro-D-erythro-hex-2,3-diulose in 75% yield after 1 week was observed.

The structure of 6-O-acyl-1,5-anhydro-D-fructose is represented below

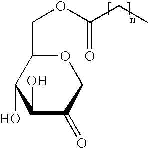

6-O-acyl-1,5-anhydro-D-fructose is particularly preferred as a compound in accordance with the present invention as it is probably readily degradable and is therefore considered to environmental friendly - JAOCS 1996, 73(7), 929-933

The preparation of 6-O-acyl-1,5-anhydro-D-fructose may be addressed by a chemical approach or by an enzymatic approach

The chemical approach may comprise the following reaction to synthesise C₁₂ esters of anhydrofructose

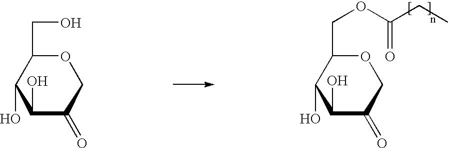

The reaction is carried out with lauroyl chloride and pyridine. The acylation sites were assigned through derivatisation of NH₂OR followed by separation and NMR of the products. The products were found to be

50% 6-O-acyl-1,5-anhydro-D-fructose

11% 3-O-acyl- 1,5-anhydro-D-fructose

Preferably the compound in accordance with the present invention is prepared from 1,5-anhydro-D-fructose prepared in accordance with GB-A-2296717. In other words, preferably the 1,5-anhydro-D-fructose is prepared by a method comprising treating an α-1,4-glucan with the enzyme α-1,4-glucan lyase characterised in that enzyme is used in substantially pure form.

The enzymatic approach to prepare 6-O-acyl-1,5-anhydro-D-fructose may comprise the use of lipases and proteases. In aqueous solution lipases and proteases cleave ester linkages. Lipases are sugar specific and proteases fatty acid specific. However, Synthesis 1990, 112-115 discloses that lipases and ptoteases in non-aqueous solution offer a reversal of activity, and form ester bonds. Thus lipases and proteases in non-aqueous solution may be used in the preparation of a compound in accordance with the present invention.

In accordance with J. Chem. Soc. Perkin Trans. I, 1995, 2203-2222 lipases were screened to identify suitable lipases for the preparation of compounds in accordance with the present invention. Screening with pyridine identified Candida antarctica, Pseudomonas cepacia, Pseudomonas fluorescens, and hog pancreas. Screening with ^{t}BuOH:pyridine 2:1 identified Candida antarctica, Candida cylindracea, Pseudomonas cepacia, Pseudomonas fluorescens, hog pancreas.

Thus preferably the compound in accordance with the present invention is prepared with a lipase obtained from Candida antarctica, Pseudomonas cepacia, Pseudomonas fluorescens, hog pancreas, or Candida cylindracea.

Preferably the compound in accordance with the present invention is prepared with lipase from Candida antarctica. Candida antarctica may be obtained from Novo Nodisk A/S, Denmark under the name Novozym 435.

The enzymatic approach was demonstrated by the enzymatic acylation of 1,5-anhydro-D-fructose with lauric acid to form 6-O-acyl-1,5-anhydro-D-fructose.

| Lauric acid | | 3 Å molecular sieve. | Temperature | Reactiontime | |
|---|---|---|---|---|---|
| (mol/mol) | Solvent | (w/w) | (° C.) | (h) | Conversion |
| 1 | tert-BuOH | — | 40 | 24 | 21% |
| 1 | tert-BuOH | 1 (powd.) | 40 | 24 | 56% |
| 1 | tert-BuOH | 1 (powd.) | 40 | 72 | 62% |
| 1 | acetone | 1 (powd.) | 20 | 24 | 55% |
| 1 | tert-BuOH | 5 | 45 | 24 | 56% |
| 1 | tert-BuOH | 10 | 45 | 24 | 61% |
| 1 | tert-BuOH | 20 | 45 | 24 | 66% |
| 3 | tert-BuOH | 20 | 45 | 24 | 73% |
| 3 | tert-BuOH | 20 (powd.) | 45 | 24 | 78% |
| 3 | tert-BuOH | 20 (powd.) | 45 | 48 | quantitative |
| 3 | acetone | 20 | 20 | 72 | quantitative |

The chemical approach may comprise the quantitative conversion with lauric, palmitic and stearic acid of 1,5-anhydro-D-fructose to 6-O-acyl-1,5-anhydro-D-fructose as follows

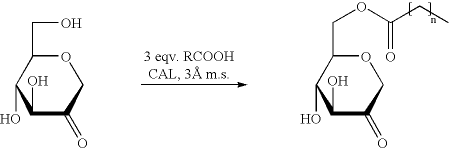

The reaction forms a composition comprising monomer ketoneldimer type 1/dimer type 2-1:3:1. The mixture may be purified by chromatography on silica to give approximately 70% yield.

The invention will now be described, by way of example only, with reference to the accompanying drawings in which:

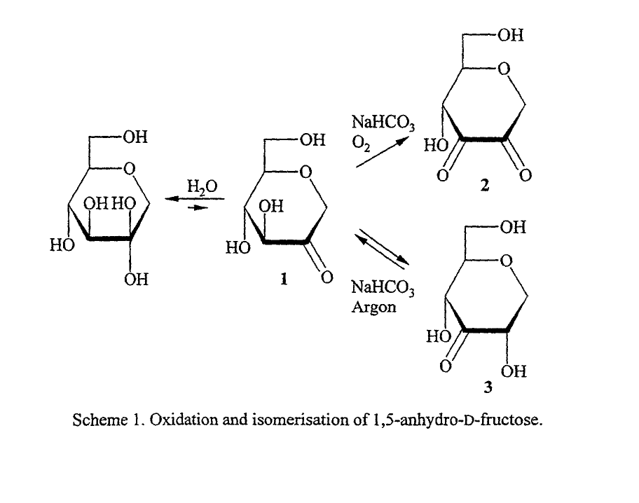

FIG. 1 shows scheme 1

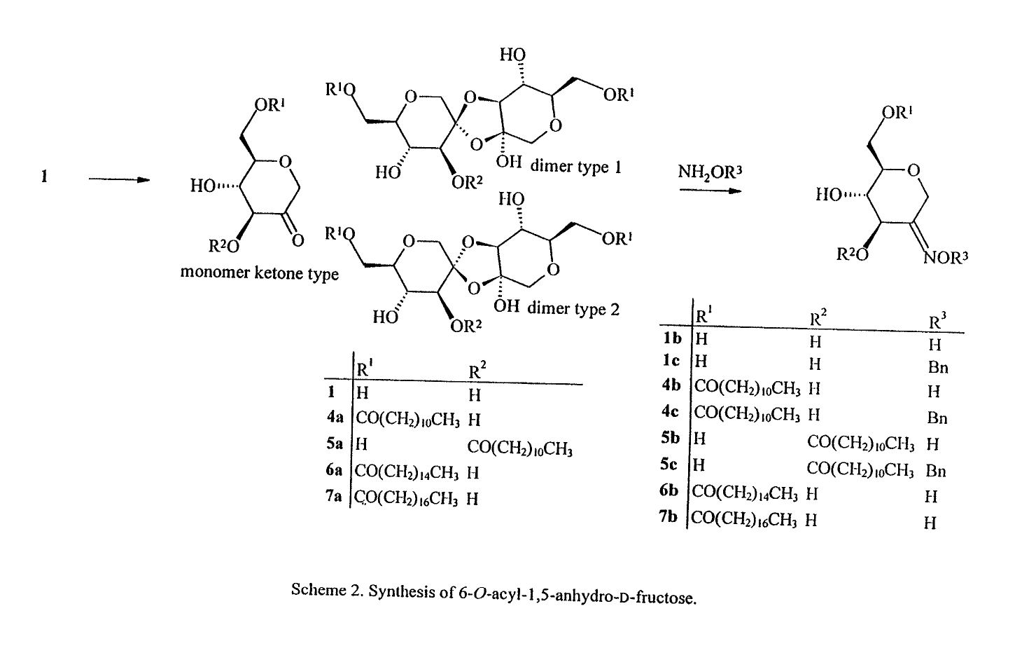

FIG. 2 shows scheme 2

FIG. 3 shows a composition not in accordance with the present invention

FIG. 4 shows a composition in accordance with the present invention

### EXAMPLES

1,5-Anhydro-D-fructose (1) can tautomerise into an enediol (FIG. 1) and might therefore be a potentially new antioxidant (similar to Lascorbic acid [1]). Antioxidants are important both in food and biological systems: In foods they are especially used to prevent oxidation of unsaturated fatty acids, while in biological systems they protect cell components from oxidative stress. Since 1,5-anhydro-D-fructose is easily produced as a degradation product from α-1,4-glucans [2-4], it is an attractive alternative to already existing antioxidants.

Enolisation of 1,5-anhydro-D-fructose.

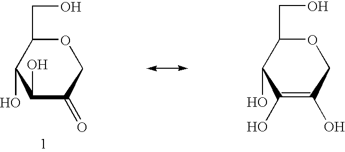

Food systems typically consist of a heterogeneous suspension of water and oil. Due to its hydrophilicity, 1,5-anhydro-D-fiructose (1) stays in the aqueous phase, and is thus not efficient for protecting the lipid phase from oxidation. Since it is known that fatty acid esters of carbohydrates have amphiphilic properties [5] and reside at the interface between the aqueous and the lipid phase, these compounds should protect the lipid phase better than 1 against oxidation. This class of compounds, non-ionic surfactants based on sugars, have many other important uses besides food applications, e.g. extraction of protein from membranes and solubilisation of hydrophobic molecules. They have also shown anti-HIV and anti-Aspergillus fumigatus activity [6].

Furthermore, fatty acid esters of carbohydrates are biodegradable, harmless and inexpensively made from renewable sources [7].

2. Results and Discussion

Use of 1,5-anhydro-D-fructose (1) as an antioxidant inevitably means oxidation of 1, hence the identification of oxidation products are important for the use of 1 in food. Oxidation of carbohydrates can be accomplished in a number of ways, e.g. treatment with H₂O₂ or O₂ [8,9]. The oxidation of 1 with molecular oxygen is especially important in order to evaluate 1 as an antioxidant in food.

Stirring an aqueous solution of 1 in an atmosphere of oxygen for one week did not cause any oxidation, but when the pH was increased to 8.5, 1 was readily oxidised at C-3 to give 1,5-anhydro-D-erythro-hexo-2,3-diulose (2) (50% conversion after 1 day and 75% after 6 days). The latter compound has also been reported as an alkaline degradation product from 2- and 3-oxo-glucopyranosides [10,11]. Reduction of the α-diketone 2 with NaBH₄ afforded the four possible stereoisomeric 1,5-anhydro-D-hexitols. Repeating the experiment in the absence of oxygen, a mixture of 1 and an isomeric compound (25%) was observed by ¹³C NMR spectroscopy. Reduction of the reaction mixture gave three of the above stereoisomeric 1,5-anhydro-D-hexitols. When the experiment was performed in D₂O the H-3 proton of 1 was replaced by deuterium within 24 h. The formed isomer likewise had one incorporated deuterium, showing the enolisation between C-2 and C-3. Based on these findings and the analogy with the alkaline degradation of 2-oxo-glucopyranosides [11], the structure of the isomer was assigned as 1,5-anhydro-D-ribo-hex-3-ulose (3). In contrast to the alkaline degradation of 1,5-anhydro-D-fructose (1) in stronger aqueous base (pH 13-14), no elimination and benzilic acid rearrangements took place to give isosaccharinic acids [12].

Scheme 1. Oxidation of 1,5-anhydro-D-fructose.

For obtaining fatty acid esters of 1 as possible antioxidative compounds, it would be important to acylate the primary hydroxyl group selectively. Monoacylation of 1,5-anhydro-D-fructose (1) could in principle be accomplished at OH-3, OH-4 or OH-6, but to avoid tedious protection and deprotection steps of 1 as well as to preserve the antioxidative activity [13,14], it was desirable to directly acylate the primary hydroxyl group. The acylation reaction of 1 was complicated by the dimeric structure of 1,5-anhydro-D-fructose [15,16]. An incomplete regioselective acylation of the primary hydroxyl group would afford seven products. To ease the monitoring of the reaction, the reaction mixture was derivatised with hydroxylamine which quantitatively converted the products to the corresponding monomeric oximes.

1,5-Anhydro-D-fructose (1) was regioselectively acylated with lauroyl chloride in pyridine at low temperature. After derivatisation with hydroxylamine and separation of the products by chromatography, 6-O-lauroyl-l,5-anhydro-D-fructose oxime (4b) (50%) and 3-O-lauroyl-1,5-anhydro-D-fructose oxime (5b) (11%) were isolated. Alternatively the carbonyl group was protected with O-benzylhydroxylamine to give the corresponding O-benzyloximes 4c and 5c. By the relative downfield shift of the hydrogens on the acylated carbon, the position of the acyl group was assigned by ¹H NMR spectroscopy. For comparison, methyl α-D-glucopyranoside can be regioselectively acylated at the primary hydroxyl group with lauroyl chloride in pyridine at low temperature in 27% yield [17]. The improved regioselectivity in the acylation of 1 was probably due to steric hindrance in the dimeric forms of 1,5-anhydro-D-fuctose (1). Employing activated esters such as N-lauroylthiazolidine-2-thiones [18] or Mitsunobu conditions [19] did not improve the regioselectivity, but caused some degradation of 1,5-anhydro-D-fructose (1). In these procedures it was necessary to add bases such as NaH, DMAP or PPh₃, which probably caused alkaline degradation. The only product isolated from the regioselective acylation of 1 with N-lauroylthiazolidine-2-thiones followed by derivatisation was the 3-O-lauroyl-1,5-anhydro-D-fructose oxime (5b). 3-0-Acylation therefore stabilises 5a against degradation, as known for similar derivatives of L-ascorbic acid [13,14].

Scheme 2. Regioselective acylation.

An attractive alternative to the chemical procedures is the use of lipases and proteases for the regioselective acylation of the primary hydroxyl group of unprotected sugars with fatty acids [20-22]. The enzymatic acylation of sugars with fatty acids can be accomplished in organic solvents [23], in a minimum of organic solvent (adjuvant technique) [24] or solvent-free [25,26]. Recently supercritical CO₂ also has been used [27].

Initially, commercial lipases from nine different organisms were screened for the regioselective acylation of 1,5-anhydro-D-fructose (1). In pyridine the lipases from Candida antarctica, Pseudomonas cepacia, Pseudomonas fluorescens and hog pancreas were active (Screening 1 in Table 1). Since polar solvents such as pyridine can inhibit the lipase activity, the screening was also performed in a mixture of tert-BuOH and pyridine (2:1 ratio). It was found that the same lipases were active together with the lipase from Candida cylindracea. Since the lipase from Candida antarctica showed a good activity compared to the others in both screenings, it was chosen for further studies.

Table 1. Screening 1 and 2.

TABLE 1
Screening of lipases for the enzymatic regioselective acylation of
1,5-anhydro-D-fructose (1).^{a}

| Lipase | Screening 1 | Screening 2 |
|---|---|---|
| Aspergillus niger | − | − |
| Candida antarctica | + | + |
| Candida cylindracea | − | + |
| Mucor miehei | − | − |
| Pseudomonas cepacia | + | + |
| Pseudomonas fluorescens | + | + |
| Rhizopus arrhizus | − | − |
| Rhizopus niveus | − | − |
| Hog pancreas | + | + |

^{a}“+” For activity and “−” for no activity

The enzymatic acylation of 1,5-anhydro-D-fructose (1) with lauric acid to 1,5-anhydro-6-O-lauroyl-D-fructose (4a) was studied in different solvents by varying the sugar:fatty acid ratio, the amount of drying agents (molecular sieves), temperature and the reaction time (Table 2). Simply stirring equimolar amounts of 1, lauric acid and lipase in tert-BuOH at 40° C. for 24 h afforded 21% conversion. The reaction is reversible, but several factors can shift the equilibrium towards complete conversion: product crystallisation, removal of water and the ratio of sugar:fatty acid. Since the acylation products from 1,5-anhydro-D-fructose (1) did not crystallise from the reaction mixture, the removal of water and the ratio 1:fatty acid were investigated. Addition of an excess of drying agent (3 Å molecular sieves) increased the conversion to 66% after 24 h. It is noteworthy that a large excess of molecular sieves was necessary in order to optimise the enzymatic reaction—much more than the capacity (20% (w/w)) of the molecular sieves. Increasing the amount of fatty acid to 3 molar equivalents, together with an excess of molecular sieves, afforded 73% conversion, and by using powdered molecular sieves, 78% conversion was obtained after 24 h. Extending the reaction time to 48 h afforded a quantitative conversion of 1 to the 6-O-lauroyl ester 4a, as shown by ³C NMR. When the enzymatic acylation was carried out in refluxing tert-BuOH or simply in melted fatty acid at 70° C. and low pressure to remove water [25,26], several byproducts were formed, such as elimination and diacylation products.

TABLE 2
Lipase-experiments.
Enzymatic acylation of 1,5-anhydro-D-fructose (1) with lauric acid.^{a}

| Lauric acid | | 3 Å molecular sieve. | Temperature | Reactiontime | |
|---|---|---|---|---|---|
| (mol/mol 1) | Solvent | (w/w 1) | (° C.) | (h) | Conversion |
| 1 | tert-BuOH | — | 40 | 24 | 21% |
| 1 | tert-BuOH | 1 (powd.) | 40 | 24 | 56% |
| 1 | tert-BuOH | 1 (powd.) | 40 | 72 | 62% |
| 1 | acetone | 1 (powd.) | 20 | 24 | 55% |
| 1 | tert-BuOH | 5 | 45 | 24 | 56% |
| 1 | tert-BuOH | 10 | 45 | 24 | 61% |
| 1 | tert-BuOH | 20 | 45 | 24 | 66% |
| 3 | tert-BuOH | 20 | 45 | 24 | 73% |
| 3 | tert-BuOH | 20 (powd.) | 45 | 24 | 78% |
| 3 | tert-BuOH | 20 (powd.) | 45 | 48 | quantitative |
| 3 | acetone | 20 | 20 | 72 | quantitative |

^{a}A typical experiment: 1,5-anhydro-D-fructose (200 mg), lauric acid, Novozym 435 (200 mg), 3Å molecular sieves and solvent (10 mL) was stirred for the time and temperature indicated. The solids were filtered off and washed with pyridine. The filtrate was concentrated; pyridine (2 mL) and NH₂OH, HCl (200 mg) was added and stirred for 1 h, followed by ¹³C NMR analysis.

To further simplify the reaction, acetone was used as a solvent and the enzymatic acylation was performed at ambient temperature. Under these reaction conditions, 1 was converted in quantitative yield to the corresponding 6-O-acylated products 4a, 6a and 7a in three to seven days (lauroyl, palmitoyl and steroyl esters of 1) (Table 3).

Table 3. Different fatty acids.

TABLE 3
Enzymatic acylation of 1,5-anhydro-D-fructose (1) with different fatty acids.^{a}

| Fatty acid | | 3 Å m.s. | Temperature | Reactiontime | |
|---|---|---|---|---|---|
| (3 mol/mol 1) | Solvent | (w/w 1) | (in ° C.) | (in h) | Conversion^{b} |
| lauric acid | acetone | 20 | 21 | 72 | quantitative (67%) |
| palmitic acid | acetone | 20 | 21 | 72 | quantitative (68%) |
| stearic acid | acetone | 20 | 21 | 168 | quantitative (65%) |

^{a}1,5-Anhydro-D-fructose (200 mg), fatty acid, Novozym 435 (200 mg), 3Å molecular sieves and solvent (10 mL) was magnetically stirred for the given time at the given temperature. The solids were filtered of and washed with pyridine. The filtrate was concentrated, added pyridine (2 mL) and NH₂OH, HCl (200 mg). Stirred for 1 h and the conversion was determined by ¹³C NMR.
^{b}The conversion shown in brackets are preparative yields of underivatised 6-O-acyl-1,5-anhydro-D-fructose after chromatography.

Like anhydrous 1,5-anhydro-D-fructose (1), the 6-O-acylated products 4a, 6a and 7a form dimeric ketals [15,16]. Thus the acylation products were present as mixtures of monomeric ketone, dimer type I and dimer type II (Scheme 2).

In conclusion, a promising enzymatic synthesis of 6-O-acylated derivatives of 1,5-anhydro-D-fructose has been achieved. These types of biodegradable fatty acid esters of 1,5-anhydro-D-fructose (1) have both antioxidative and emulsifying properties.

Table 4. ¹³C NMR.

TABLE 4
¹³C NMR of isolated compounds in pyridine-d₅.^{a}

| Compound | C-1 | C-2 | C-3 | C-4 | C-5 | C-6 |
|---|---|---|---|---|---|---|
| 1b | 61.9 | 155.7 | 74.8 | 74.0 | 82.7 | 63.2 |
| 1c | 62.2 | 157.8 | 74.4 | 73.5 | 82.8 | 63.1 |
| 4b | 61.6 | 155.0 | 74.9 | 73.8 | 79.2 | 64.8 |
| 4c | 61.9 | 157.1 | 74.4 | 73.4 | 79.2 | 64.6 |
| 5b | 62.1 | 151.3 | 75.5 | 70.4 | 82.9 | 62.8 |
| 5c | 62.1 | 152.5 | 75.0 | 70.1 | 82.8 | 62.4 |
| 6b | 61.6 | 155.0 | 74.9 | 73.8 | 79.2 | 64.8 |
| 7b | 61.6 | 155.0 | 74.9 | 73.8 | 79.2 | 64.8 |

^{a}δ-Values (ppm) for 1b, 1c, 4b, 4c, 5b (125 MHz), 5c, 6b, 7b (62.9 MHz); signals were assigned by C-H correlated NMR; solventpeaks used as reference (δ 149.9, 135.5 and 123.5 ppm).

Table 5. ¹H NMR.

¹H NMR of isolated compound in pyridine-d₅.^{a}

| Compound | H-1a | H-1b | H-3 | H-4 | H-5 | H-6a | H-6b |
|---|---|---|---|---|---|---|---|
| 1b | 4.27 (d) | 5.68 (d) | 4.89(d) | 4.38 (broad t) | 3.99 (ddd) | 4.31 (dd) | 4.49 (dd) |
| | J_{1a,1b} 14.5 | | J_{3,4} 7.5 | J_{4,5} 8.5 | J_{5,6a} 6.0 | J_{6a,6b} 11.5 | |
| | | | | | J_{5,6b} 2.5 | | |
| 1c | 4.21 (d) | 5.42 (d) | 4.83 (d) | 4.39 (dd) | 3.95 (ddd) | 4.29 (dd) | 4.45 (dd) |
| | J_{1a,1b} 15.0 | | J_{3,4} 7.5 | J_{4,5} 8.5 | J_{5,6a} 5.5 | J_{6a,6b} 12.0 | |
| | | | | | J_{5,6b} 2.5 | | |
| 4b | 4.24 (d) | 5.68 (d) | 4.87 (d) | 4.22 (broad t) | 4.06 (ddd) | 4.77 (dd) | 4.97 (dd) |
| | J_{1a,1b} 14.5 | | J_{3,4} 8.0 | J_{4,5} 8.5 | J_{5,6a} 6.5 | J_{6a,6b} 12.0 | |
| | | | | | J_{5,6b} 2.0 | | |
| 4c | 4.17 (d) | 5.40 (d) | 4.80 (d) | 4.21 (broad t) | 4.02 (ddd) | 4.75 (dd) | 4.91 (dd) |
| | J_{1a,1b} 14.5 | | J_{3,4} 7.5 | J_{4,5} 8.5 | J_{5,6a} 6.5 | J_{6a,6b} 11.5 | |
| | | | | | J_{5,6b} 2.5 | | |
| 5b | 4.24 (d) | 5.63 (d) | 6.16 (d) | 4.53 (broad t) | 3.95 (ddd) | 4.29 (dd) | 4.41 (dd) |
| | J_{1a,1b} 14.5 | | J_{3,4} 7.5 | J_{4,5} 8.0 | J_{5,6a} 5.5 | J_{6a,6b} 12.0 | |
| | | | | | J_{5,6b} 2.5 | | |
| 5c | 4.08 (d) | 5.38 (d) | 6.10 (d) | 4.52 (broad t) | 3.92 (ddd) | 4.28 (dd) | 4.39 (dd) |
| | J_{1a,1b} 15.0 | | J_{3,4} 7.0 | J_{4,5} 8.5 | J_{5,6a} 5.0 | J_{6a,6b} 12.0 | |
| | | | | | J_{5,6b} 2.5 | | |
| 6b | 4.23 (d) | 5.70 (d) | 4.87 (d) | 4.23 (broad t) | 4.07 (ddd) | 4.77 (dd) | 4.98 (dd) |
| | J_{1a,1b} 14.5 | | J_{3,4} 8.0 | J_{4,5} 8.0 | J_{5,6a} 6.5 | J_{6a,6b} 12.0 | |
| | | | | | J_{5,6b} 2.0 | | |
| 7b | 4.21 (d) | 5.68 (d) | 4.86 (d) | 4.21 (broad t) | 4.05 (ddd) | 4.76 (dd) | 4.97 (dd) |
| | J_{1a,1b} 14.5 | | J_{3,4} 8.0 | J_{4,5} 8.5 | J_{5,6a} 6.5 | J_{6a,6b} 12.0 | |
| | | | | | J_{5,6b} 2.0 | | |

^{a}Δ-Values (ppm) and coupling constants (J, Hz) for 1b, 1c, 4b, 4c, 5b (500 MHz), 5c, 6b, 7b (250 MHz); signals were assigned by 2D-COSY NMR; solventpeaks was used as reference (δ 8.71, 7.55 and 7.19 ppm).

3. Experimental

General methods.—1,5-Anhydro-D-fructose (1) was freeze-dried from an aqueous solution and residual water coevaporated with toluene three times before use. Molecular sieves were activated with a heatgun in a flow of argon. tert-BuOH and pyridine were distilled from CaH₂ onto 3 Å molecular sieves, acetone was dried over MgSO₄ and lauroyl chloride was distilled prior to use. The enzymes used in the screenings were dried in vacuo over “Blue Gel” for 2 days. The reactions were performed in an argon atmosphere, unless otherwise stated. ¹H NMR and ¹³C NMR spectra were recorded on Bruker instruments AC 250 (ambient temperature) or AM 500 (300 K). For ¹H and ³C NMR spectra in pyridine the solvent peak was used as a reference. For ¹³ C NMR in D₂O, acetone (δ=30.89 ppm) was used as internal reference. Melting points are uncorrected. Optical rotations were measured on a Perkin-Elmer 241 polarimeter. Microanalyses were carried out by The Microanalytical Department, University of Copenhagen and Institut für Physikalische Chemie, University of Wien. TLC was performed on precoated kieselgel 60 F₂₅₄ and spots were visualised by spraying with a mixture of 1.5% (w/w) (NH₄)₆Mo₇O₂₄4H₂O, 1% (w/w) Ce(SO₄)₂4H₂O and 10% (v/v) H₂SO₄, followed by heating. Flash chromatography was performed on silica gel 60 (Grace AB Amicon, 35-70 μm). HPLC was performed on a Waters 8NVC186 reverse phase column, with an evaporative light scattering detector (ELSD). Evaporations were performed in vacuo at temperatures below 45° C.

Oxidation of 1,5-anhydro-D-fructose (1).—1,5-Anhydro-D-fructose (1) (464 mg, 2.9 mmol) was dissolved in H₂O (5 mL) and left for 24 h. NaHCO₃ (257 mg, 3.0 mmol) was added, resulting in pH 8.5, and the reaction mixture was stirred under an atmosphere of O₂. The reaction was followed by ¹³C NMR. After 24 h: 50% conversion to 1,5-anhydro-D-erythro-hexo-2,3-diulose (2) and after 6 days: 75% conversion. A sample was reduced with NaBH₄ to the four possible 1,5-anhydro-D-hexitols, as seen by ³C NMR.

1,5-Anhydro-D-erythro-hexo-2,3-diulose (2) in D₂O (62.9 MHz, signals assigned by DEPT): δ179.1 and 178.5 (C-2 and C-3), 83.5 (C-5), 70.5 (C-4), 69.5 (C-1) and 61.6 (C-6).

1,5-Anhydro-D-fructose (1) in weakly alkaline aqueous solution.—1,5-Anhydro-D-O fructose (1) (639 mg, 3.9 mmol) was dissolved in H₂O (10 mL) and left for 24 h. NaHCO₃ (333 mg, 4.0 mmol) was added, resulting in pH 8.5, and the reaction was followed by ¹³C NMR. After 24 h an equilibrium was reached between 1 (75%) and an isomer: 1,5-anhydro-D-ribo-hex-3-ulose (3) (25%). A sample was reduced with NaBH₄ to three of the above 1,5-anhydro-D-hexitols, as seen by ¹³C NMR.

The alkaline rearrangement of 1,5-anhydro-D-fructose (1) was repeated in D₂O where H-3 of 1 and H-2 of 3 were replaced by deuterium within 24 h, as seen by ¹³C NMR.

1,5-Anhydro-D-ribo-hex-3-ulose (3) in D₂O (62.9 MHz, signals assigned by DEPT and from the alkaline degradation of 1 in D₂O): δ206.2 (C-3), 75.8 (C-S), 73.1 (C-2), 68.4 (C-1), 66.8 (C-4) and 62.1 (C-6).

1,5-Anhydro-6-O-lauroyl-D-fructose oxime (4b) and 1,5-anhydro-3-O-lauroyl-D-fructose oxime (5b).—1,5-Anhydro-D-fructose (1) (1.0 g, 6.3 mmol) was dissolved in pyridine (30 mL) and the solution was cooled to 0° C. Lauroyl chloride (1.50 mL, 6.3 mmol) was added dropwise and the reaction mixture was stirred for 1 h at 0° C. and 3 h at ambient temperature. Then MeOH (1 mL) was added and after 1 h NH₂OH, HCl (660 mg, 9.5 mmol) were added and the mixture was stirred for 24 h. The reaction mixture was concentrated and the products were separated by chromatography (64 g silica, eluted with hexane:EtOAc 3:1 to 1:2) to give 1,5-anhydro-6-O-lauroyl-D-fructose oxime (4b) (1.1 g, 50%), mp 89-96° C., and 1,5-anhydro-3-O-lauroyl-D-fructose oxime as a syrup (5b) (250 mg, 11%). Analytical samples of 4b and 5b were prepared by chromatography.

1,5-Anhydro-6-O-lauroyl-D-fructose oxime (4b): mp 90-101° C.; [α]_{D}−13.5° (c 1.1 MeOH). Anal. Calcd for C₁₈H₃₃NO₆: C, 60.14; H, 9.25; N, 3.90. Found: C, 60.35; H, 9.18; N, 4.10).

1,5-Anhydro-3-O-lauroyl-D-fructose oxime (5b): [α]_{D}−45.7° (c 1.1 MeOH). HRMS calcd for C₁₈H₃₃NO₆: 359.2309 (M); found: 359.2297.

1, 5-Anhydro-6-O-lauroyl-D-fructose O-benzyloxime (4c) and 1,5-anhydro-3-O-lauroyl-D-fructose O-benzyloxime (5c).—Using the same procedure as above, 1,5-anhydro-D-fructose (1) (227 mg, 1.4 mmol) was acylated with lauroyl chloride (0.332 mL, 1.4 mmol) in pyridine (10 mL) followed by addition of BnONH₂, HCl (236 mg, 1.5 mmol). After stirring for 24 h the mixture was concentrated. The products were separated by chromatography (20 g silica, eluted with hexane:EtOAc 3:1 to 1:1) to give 1,5-anhydro-6-O-lauroyl-D-fructose O-benzyloxime (4c) (287 mg, 46%) and 1,5-anhydro-3-O-lauroyl-D-fructose O-benzyloxime (5c) (43 mg, 7%). Analytical samples of 4c and 5c were prepared by chromatography.

1,5-Anhydro-6-O-lauroyl-D-fructose O-benzyloxime (4c): mp 45-50° C.; [α]_{D}−9.6° (c 1.0 MeOH). HRMS calcd for C₂₅H₃₉NO₆: 450.2856 (M+H⁺); found: 450.2854.

1,5-Anhydro-3-O-lauroyl-D-fructose O-benzyloxime (5c): mp 48-51° C.; [α]_{D}−51.7° (c 1.3 MeOH). HRMS calcd for C₂₅H₃₉NO₆: 450.2856 (M+H⁺); found: 450.2845.

Screening of lipases for the regioselective esterification of 1,5-anhydro-D-fructose (1). —screening 1. A solution of 1,5-anhydro-D-fructose (1) (308 mg, 1.9 mmol), lauroyl O-acetoxime (480 mg, 1.9 mmol) and pyridine (13 mL) was prepared. 1 mL of this solution was added to approximately 10 mg of lipase in an Eppendorf tube, and the mixture was shaken (1000 rpm) at 30° C. for 4 days and centrifuged (14000 rpm, 5 min.). A sample (0.5 mL) of the supernatant was added to 0.5 M NH₂OH (pyridine) (0.5 mL) and left for 24 h. The solution was analysed by HPLC.

Screening 2. The enzymatic reactions were performed in tert-BuOH:pyridine (2:1) using the same procedure as screening 1.

Enzymatic regioselective acylation of 1,5-anhydro-D-fructose (1).

1,5-Anhydro-6-O-lauroyl-D-fructose (4a).—1,5-Anhydro-D-fructose (1) (1.1 g, 6.7 mmol), lauric acid (4.0 g, 20.2 mmol), Novozym 435 (1.1 g) and 3 Å molecular sieves (21.8 g) were suspended in acetone (95 mL) and stirred for 72 h. Pyridine (30 mL) was added to the reaction mixture and the solids were filtered off and washed with pyridine (2×30 mL). The filtrate was concentrated in vacuo to a syrup (6.3 g). To a sample (377 mg) was added pyridine (1.5 mL) and NH₂OH, HCl (116 mg). The solution was stirred for 1 h and was shown by ¹³C NMR to consist of only 1,5-anhydro-6-O-lauroyl-D-fructose oxime (4b). The remaining syrup (5.9 g) was purified by chromatography (100 g silica, eluted with hexane:EtOAc:EtOH, 4:1:0 then 0:4:1) to afford 1,5-anhydro-6-O-lauroyl-D-fructose (4a) as an amorphous solid (1.5 g, 67%). This preparation was shown by ¹³C NMR [16] to consist of monomeric ketone (δ82.6; C-5) (20%), dimer type I (δ88.3, C-3′) (60%) and dimer type II (δ89. 1, C-3′) (20%). To a sample of this mixture (72 mg) was added NH₂OH, HCl (75 mg) and pyridine (1 mL). The solution was stirred for 1 h and was shown by 13C NMR to consist of only 1,5-anhydro-6-O-lauroyl-D-fructose oxime (4b).

1,5-Anhydro-6-O-palmitoyl-D-fructose (6a).—using the same procedure as for 4a, a mixture of 1,5-anhydro-D-fructose (1) (1.0 g, 6.3 mmol), palmitic acid (4.9 g, 19.0 mmol), Novozyme 435 (1.0 g), acetone (95 mL) and 3 Å molecular sieves (20.6 g) was stirred for 72 h, followed by workup, to give a crude residue (6.7 g). To a sample (340 mg) was added pyridine (1.5 mL) and NH₂OH, HCl (116 mg). The solution was stirred for 1 h and was shown by 13C NMR to consist of only 1,5-anhydro-6-O-palmitoyl-D-fructose oxime (6b). The remaining syrup (6.4 g) was purified by chromatography (100 g silica, eluted with hexane:EtOAc:EtOH, 4:1:0 then 0:4:1) to afford 1,5-anhydro-6-O-palmitoyl-D-fructose (6a) as an amorphous solid (1.6 g, 68%). This preparation was shown by ³C NMR [16] to consist of monomeric ketone (δ82.6, C-5) (20%), dimer type I (δ88.3, C-3′) (20%) and dimer type II (6 89. 1, C-3) (60%). To a sample (58 mg) were added pyridine (1 mL) and NH₂OH, HCl (57 mg). The solution was stirred for 1 h and was shown by 13C NMR to consist of only 1,5-anhydro-6-O-palmitoyl-D-fructose oxime (6b). An analytical sample of 6b was prepared by chromatography: mp 97-104° C.; [α]_{D}−13.40° (c 1.1 MeOH). Anal. Calcd for C₂₂H₄₁NO₆: C, 63.59; H, 9.94; N, 3.37. Found: C, 63.80; H, 9.69; N, 3.65.

1,5-Anhydro-6-O-stearoyl-D-fructose (7a).—By the same procedure as for 4a, a mixture of 1,5-anhydro-D-fructose (1) (1.1 g, 6.6 mmnol), stearic acid (5.7 g, 20.0 mmol), Novozyme 435 (1.1 g), acetone (95 mL) and 3 Å molecular sieves (21.7 g) was stirred for 168 h. Workup gave a crude residue (7.5 g). To a sample (230 mg) was added pyridine (1.0 mL) and NH₂OH, HCl (110 mg). The solution was stirred for 1 h and was shown by ¹³C NMR to consist of only 1,5-anhydro-6-O-stearoyl-D-fructose oxime (7b). The remaining residue (7.3 g) was purified by chromatography (100 g silica, eluted with hexane:EtOAc:EtOH 8:1:0 then 0:4:1) to afford 1,5-anhydro-6-O-stearoyl-D-fructose (7a) as an amorphous solid (1.8 g, 65%). This preparation was shown by ¹³C NMR [16] to consist of monomeric ketone (δ82.6, C-5) (25%), dimer type I (δ88.3, C-3′) (50%) and dimer type II (δ89.1, C-3′) (25%). To a sample (69 mg) were added pyridine (0.7 mL) and NH₂OH, HCl (73 mg). The solution was stirred for 1 h and was shown by ¹³C NMR to consist of only 1,5-anhydro-6-O-stearoyl-D-fructose oxime (7b). An analytical sample of 7b was prepared by chromatography: mp 99-105° C.; [α]_{D}−13.0° (c 1.1 MeOH). Anal. Calcd for C₂₄H₄₅NO₆: C, 64.98; H, 10.22; N, 3.16. Found: C, 64.70; H, 9.82; N, 3.15.

Use of Compound as Anti-Oxidant

Use of Compound as an anti-oxidant in a 50% mayonnaise.

50% mayonnaise is used for salads, open sandwiches, etc. in both the catering and the retail trades. The low oil content of 50% mayonnaise makes it suitable for low-calorie applications.

A typical mayonnaise composition is as follows:

| | |
|---|---|
| Soya oil | 50.0% |
| Tarragon vinegar (10%) | 4.0% |
| Egg yolk | 3.5% |
| Sugar | 3.0% |
| Salt | 1.0% |
| Potassium sorbate | 0.1% |
| Water | 35.2% |
| MAYODAN 602 | 3.0% |
| Lemon flavouring 10251 | 0.2% |

MAYODAN 602 ensures a fine, stable oil dispersion and the required viscosity, thereby providing 50% mayonnaise with a long shelf life.

Flavouring 10251 is a natural lemon flavouring which provides mayonnaise with the fresh taste of lemon.

Typically the mayonnaise is prepared by the following method:

1) Dry mix the MAYODAN 602, sugar and salt. Disperse in oil in a ratio of 1 part powder to 2 parts oil.

2) Add flavouring and potassium sorbate to the water and pour into the Koruma mixer. Add 1).

3) Add the egg yolk.

4) Add the oil continuously in a vacuum.

5) After ⅔ of the oil has been added (slowly), blend the tarragon vinegar with the remaining ⅓ of the oil, and add.

When the compound of the present invention is added to the mayonnaise as an anti-oxidant the results are comparable to the known food anti-oxidants GRINDOX 142 and GRINDOX 1029.

| | |
|---|---|
| GRINDOX 142: | |
| Ascorbyl palmitate | 10% |
| Propyl gallate | 20% |
| Citric acid | 10% |
| Food grade emulsifier | 60% |
| Form at 25° C. | paste |
| Colour | grey to pale brown |
| Density | 1.1 g/ml |
| GRINDOX 1029: | |
| Ascorbyl palmitate | 20% |
| Natural tocopherols | 20% |
| Food grade emulsifier | 60% |
| Form at 25° C. | paste |
| Colour | light brown |
| Density at 25° C. | 1.0 g/ml |

(All percentages are by weight)

In the test procedure the anti-oxidant compounds were added to the mayonnaise to provide an anti-oxidant concentration in the order of about 500 ppm. The mayonnaise was then placed in a bomb calorimeter at temperature 80° C containing pure O₂ . An induction period to the onset of substantial oxidation of the product is then measured.

The results show that the compounds of the present invention are excellent food anti-oxidants and are comparable with the known foodstuffs anti-oxidants GRINDOX 142 or GRINDOX 1029.

Use of Compounds as an anti-oxidant in a voghurt salad dressing with 50% oil

Yoghurt salad dressing with 50% oil is used for salads, potatoes, raw vegetable salad, meat, fish and boiled vegetables.

Composition

| | |
|---|---|
| Soya oil | 50.0% |
| Yoghurt (plain) | 39.0% |
| Vinegar (10%) | 3.5% |
| Sugar | 3.0% |
| Egg yolk | 2.0% |
| Salt | 1.0% |
| Potassium sorbate | 0.1% |
| MAYODAN 525 | 1.4% |
| Acid masking flavouring 2072 | 0.02% |

MAYODAN 525 provides unique emulsion stability, prevents syneresis, ensures uniform oil dispersion and viscosity, improves tolerance to production processes and ensures a long shelf life.

Flavouring 2072 is a nature-identical, acid masking flavouring reducing the acidulated taste of dressing without affecting its pH value.

Process

1. Dry mix MAYODAN 525, sugar and salt. Disperse in oil in a ratio of 1 part powder to 2 parts oil.

2. Fill flavouring, potassium sorbate and yoghurt into the Koruma mixer. Add 1).

3. Add the egg yolk.

4. Add the oil continuously in a vacuum.

5. After ⅔ of the oil has been added (slowly), blend the vinegar with the remaining ⅓ of the oil, and add.

6. Add spices if required.

The compositions were tested as described above. The results show that the compounds of the present invention are excellent food anti-oxidants.

Emulsifying Properties

Test of compound of interest as emulgator in a w/o emulsifier

Materials:

1) 83.4% soya bean oil (84 ml)

16.6% water (16.6 g)

2) 83.4% soya bean oil (84 ml)

16.2% water (16.2 g)

0.4% GRINDSTED® CITREM BC (0.4 g)

3) 83.4% soya bean oil (84 ml)

16.2% water (16.2 g)

0.4% DIMODAN PVP (0.4 g)

4) 83.4% soya bean oil (84 ml)

16.2% water (16.2g)

0.4% COMPOUND OF INTEREST (0.4 g)

Methods:

1. The oil is heated to 60° C.

2. 84 ml wann soya bean oil (with or without emulsifier) is weighed in a 400 ml cup and then stirred (Heidolph, speed 2.5) in a waterbath at 60° C.

3. The weighed quantity of distilled water (pH 4.7) is added to the oil during while being stirred. The stirring is continued for 20 minutes, and the emulsion is kept at 60° C.

Just after the emulsification, a sample of the emulsion is studied in a microscope. The rest of the emulsion is poured into a cup which is placed at room temperature. Separation of water and possibly oil after some time is followed.

Results

| | | | | Com- |
|---|---|---|---|---|
| | No | GRINDSTED ® | DIMODAN ® | pound |
| | emulsifier | CITREM BC | PVP | of Interest |
| Size of drops | Large | Small and | Medium size | Small + |
| just after | drops | finely spread | drops - look | medium |
| emulsi- | | drops | stable | size drops. |
| fication * | | | | Finely |
| | | | | spread. |
| Stability ** | 5 min | 60 min | 60 min | 20 min |

* photos from light microscope to follow.
** Time before approx. 15 ml water was separated from the emulsion.

Conclusions

The Compound of Interest acts as w/o emulsifier. The Cols emulsification properties-assessed as the ability to create small water drops—are close to GRINDSTED® CITREM BS and better than DIMODAN® PVP. The emulsification with the CoI is considerably more stable than the control without emulsifier.

GRINDSTED® CITREM BC is Citric Acid Ester/Monoglyceride Blend

DIMODAN® PVP is Distilled Monoglyceride.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

The present invention will now be described by the following numbered paragraphs:

1. A derivatised anhydrofructose comprising a hydrophobic group linked (directly or indirectly) to a C of an anhydrofructose moiety.

2. A derivatised anhydrofructose according to paragraph 1, wherein the hydrophobic group is attached indirectly to a C of an anhydrofructose moiety.

3. A derivatised anhydrofurctose according to paragraph 2, wherein the hydrophobic group is attached to the C₆ of the anhydroffructose moiety.

4. A derivatised anhydrofructose according to paragraph 3, wherein the hydrophobic group is attached to C₆ of the anhydrofrucotse moiety via an ester group.

5. A derivatised anhydrofructose according to any one of paragraphs 1 to 4, wherein the hydrophobic group is a fatty acid.

6. A derivatised anhydrofructose according to any one of paragraphs 1 to 5, wherein the derivatised anhydrofructose is prepared by chemically derivatising anhydrofructose.

7. A derivatised anhydrofructose according to any one of paragraphs 1 to 5, wherein the derivatised anhydrofructose is prepared by enzymatically derivatising anhydrofructose.

8. An antioxidant composition comprising the derivatised anhydrofrucotse according to any one of paragraphs 1 to 7 optionally in admixture with any suitable carrier or diluent.

9. Use of a derivatised anhydrofructose according to any one of paragraphs 1 to 7 as an antioxidant.

10. Use of a derivatised anhydrofructose according to any one of paragraphs 1 to 7 as an emulsifier.

11. Use of a derivatised anhydrofructose according to any one of paragraphs 1 to 7 as an antioxidant and as an emulsifier.

12. A food product, or a composition for use in the manufacture of a food product, comprising a derivatised anhydrofructose according to any one of paragraphs 1 to 7.

13. A derivatised anhydrofructose as substantially hereinbefore described with reference to any one of the Examples.

14. An antioxidant composition as substantially hereinbefore described with reference to any one of the Examples.

15. A method of using a derivatised anhydrofructose as substantially hereinbefore described with reference to any one of the Examples.

16. A food product comprising a derivatised anhydrofructose as substantially hereinbefore described with reference to any one of the examples.

17. A composition for use in the manufacture of a food product comprising a derivatised anhydrofructose as substantially hereinbefore described with reference to any one of the examples.

References

[1] T. Kurata, N. Miyake, and Y. Otsuka, Biosci. Biotech. Biochem., 60(7) (1996) 1212-1214.

[2] S. Yu and M. Pedersen, Planta, 191 (1993) 137-142.

[3] S. Yu, L. Kenne, and M. Pedersen, Biochim. Biophys. Acta, 1156 (1993)313- 320.

[4] S. Yu, T. Ahmad, L. Kenne, and M. Pedersen, Biochim. Biophys. Acta, 1244 (1995) 1-9.

[5] A. Ducret, A. Giroux, M. Trani, and R. Lortie, JAOCS, 73(1) (1996)109-113.

[6] I. Rico-Lattes and A. Lattes, Colloids and Surfaces A, 123-124 (1997) 37-48.

[7] T. Madsen, G. Petersen, C. Seierø, and J. Tørsløv, JAOCS, 73(7) (1996) 929-933.

[8] S. J. H. F Arts, E. J. M. Mombarg, H. van Bekkum, and R. A. Sheldon, Synthesis,(1997) 597-613.

[9] P. O. Kvernberg and B. Pedersen, Acta Chem. Scand., 48 (1994) 646-651.

[10] O; Theander, Acta Chem. Scand., 12 (1958) 1887-1896.

[11] H.-M. Liuand Y. Tsuda, Chem. Pharm. Bull.,44(1)(1996)80-87.

[12] T. Ahmad, Thesis, Uppsala, Sweden, 1995.

[13] K. Morisaki and S. Ozaki, Chem. Pharm. Bull., 44(9) (1996) 1647-1655.

[14] K. Morisaki and S. Ozaki, Carbohydr. Res., 286 (1996) 123-138.

[15] S. Freimund and S. Kopper, Carbohydr. Res., 308 (1998) 195-200.

[16] S.M. Andersen, I. Lundt, J. Marcussen, I. Søtofte, and S. Yu, J. Carbohydr. Chem., 17(7) (1998) 1027-1035.

[17] E. Reinefeld and H.-F. Korn, Die Stärke, 20(6) (1968) 181-189.

[18] D. Plusquellec and K. Baczko, Tetrahedron Lett., 28(33) (1987) 3809-3812.

[19] S. Bottle and I.D. Jenkins, J. Chem. Soc., Chem. Commun., (1984) 385.

[20] M. Therisod and A.M. Klibanov, J. Am. Chem. Soc., 108(18) (1986) 5638-5640.

[21] K. Faber and S. Riva, Synthesis, (1992) 895-910.

[22] N. B. Bashir, S. J. Phythian, A. J. Reason, and S. M. Roberts, J. Chem. Soc., Perkin Trans. 1, (1995) 2203-2222.

[23] J. A. Arcos, M. Bemabe, and C. Otero, Biotech. Bioeng., 57(5) (1998) 505-509.

[24] L. Cao, U. T. Bornscheuer, and R. D. Schmid, Fett/Lipid, 98(10) (1996) 332-335.

[25] F. Björkling, S. E. Godtfredsen, and Kirk, J. Chem. Soc., Chem. Commun. (1989) 934-935.

[26] K. Adelhorst, F. Björkling, S. E. Godtfredsen, and 0. Kirk, Synthesis, (1990), 112-115.

[27] C. Tsitsimpikou, H. Stamatis, V. Sereti, H. Daflos, and F. N. Kolisis, J. Chem. Technol. Biotechnol., 71 (1998) 309-314.

We claim:

1. A derivatised anhydrofructose comprising a hydrophobic group linked (directly or indirectly) to a C of an anhydrofructose moiety.

2. A derivatised anhydrofructose according to claim 1, wherein the hydrophobic group is attached indirectly to a C of an anhydrofructose moiety.

3. A derivatised anhydrofurctose according to claim 2, wherein the hydrophobic group is attached to the C₆ of the anhydrofructose moiety.

4. A derivatised anhydrofructose according to claim 3, wherein the hydrophobic group is attached to C₆ of the anhydrofrucotse moiety via an ester group.

5. A derivatised anhydrofructose according to of claim 1, wherein the hydrophobic group is a fatty acid.

6. A derivatised anhydro fructose according to claim 1, wherein the derivatised anhydrofructose is prepared by chemically derivatising anhydrofructose.

7. A derivatised anhydrofructose according to claim 1, wherein the derivatised anhydrofructose is prepared by enzymatically derivatising anhydrofructose.

8. An antioxidant composition comprising the derivatised anhydrofrucotse according to claim 1 optionally in admixture with any suitable carrier or diluent.

9. A method for using the derivatised anhydrofructose of claim 1 as an antioxidant.

10. A method for using the derivatised anhydrofructose of claim 1 as an emulsifier.

11. A method for using the derivatised anhydrofructose of claim 1 as an antioxidant and as an emulsifier.

12. A food product comprising a derivatised anhydrofructose according to claim 1.

13. A composition for use in the manufacture of a food product comprising a derivatised anhydrofructose according to claim 1.

14. A derivatised anhydrofructose as substantially hereinbefore described with reference to any one of the examples.

15. An antioxidant composition as substantially hereinbefore described with reference to any one of the examples.

16. A method of using a derivatised anhydrofructose as substantially hereinbefore described with reference to any one of the Examples.

17. A food product comprising a derivatised anhydrofructose as substantially hereinbefore described with reference to any one of the examples.

18. A composition for use in the manufacture of a food product comprising a derivatised anhydrofructose as substantially hereinbefore described with reference to any one of the examples.
